(19) United States
(12) Patent Application Publication
(10) Pub. No.: US 2016/0323954 A1
(43) Pub. Date: Nov. 3, 2016

(54) DRIVING CIRCUIT OF LIGHT SOURCE AND CONTROL CIRCUIT THEREOF, DRIVING METHOD OF LIGHT SOURCE, LIGHTING APPARATUS, AND ELECTRONIC DEVICE

(71) Applicant: ROHM CO., LTD., Ukyo-ku (JP)

(72) Inventors: Takeshi NOZAWA, Ukyo-ku (JP); Shingo HARUTA, Ukyo-ku (JP)

(21) Appl. No.: 15/139,663

(22) Filed: Apr. 27, 2016

(30) Foreign Application Priority Data
May 1, 2015 (JP) 2015-094313

(51) Int. Cl. H05B 33/08; G02F 1/1335

(52) U.S. Cl. CPC H05B 33/0851; H05B 33/0815; G02F 1/1336

(57) ABSTRACT

A control circuit of a driving circuit for supplying a driving current to a light source includes: a pulse width modulation (PWM) input terminal configured to receive an input dimming pulse having an input duty ratio corresponding to a target light quantity of the light source, the input dimming pulse being pulse-width modulated; and a dimming controller configured to convert a period and a pulse width of the input dimming pulse into digital values, reconvert the digital values into an output dimming pulse having an output duty ratio which is the same as or different from the input duty ratio, and control the driving current to be on and off based on the output dimming pulse.

### CROSS-REFERENCE TO RELATED APPLICATION

This application is based upon and claims the benefit of priority from Japanese Patent Application No. 2015-094313, filed on May 1, 2015, the entire contents of which are incorporated herein by reference.

### TECHNICAL FIELD

The present disclosure relates to a driving circuit of a light source.

### BACKGROUND

Semiconductor light sources such as light emitting diodes (LEDs) as a liquid crystal backlight or a lighting device have become prevalent. FIG. 1 is a circuit diagram of a driving circuit of an LED. The driving circuit (LED driver 90R) includes a constant current converter 100R and a control circuit 300R. The constant current converter 100R receives an input voltage V_{IN} from a power source (not shown) by an input line 104 and boosts the received voltage V_{IN} to supply an output voltage V_{OUT} to an LED light source 502 as a load connected to an output line 106 and also stabilize a current (a load current or a driving current) I_{LED} flowing in the LED light source 502 to a target value I_{REF}. For example, the LED light source 502 is an LED string.

The constant current converter 100R is, for example, a boost converter, and includes a smoothing capacitor C1, a rectifying diode D1, a switching transistor M1, an inductor L1, and a detection resistor R_{CS}.

As a method for changing a quantity of light (brightness) of the LED light source 502, analog dimming and pulse width modulation (PWM) dimming have been known. FIG. 2 is a waveform view illustrating analog dimming and PWM dimming.

The analog dimming changes the amplitude (current amount) of the driving current I_{LED}. For the analog dimming, an error amplifier 304 and a duty controller 306 are provided. The current I_{LED} flowing in the LED light source 502 flows into the detection resistor R_{CS} to generate a voltage drop in proportion to the current I_{LED} of the detection resistor R_{CS}. The voltage drop as a detection voltage V_{CS} is input to a current detection (CS) terminal of the control circuit 300R. An analog dimming voltage V_{ADIM} representing the target value I_{REF} of the load current I_{LED} from an external host processor 400 is input to an analog dimming (ADIM) terminal of the control circuit 300R. The control circuit 300R generates a driving pulse S_{DRV} whose duty ratio is adjusted such that the detection voltage V_{CS} is identical to the analog dimming voltage V_{ADIM}, and drives a switching transistor M1.

The error amplifier 304 amplifies an error between the detection voltage V_{CS} and the analog dimming voltage V_{ADIM} to generate a feedback signal V_{FB} corresponding to the error. For example, the error amplifier 304 includes a transconductance amplifier (gm amplifier), and a resistor R_{FB} and a capacitor C_{FB} for phase compensation connected to an output thereof. The duty controller 306 is a so-called pulse modulator, and generates the driving pulse S_{DRV} having a duty ratio based on the feedback signal V_{FB}. The driver 308 switches the switching transistor M1 according to the driving signal S_{DRV}.

In this constant current converter 100R, the feedback signal V_{FB} is applied such that the following relational expression is established.

I_{LED}×R_{CS}=V_{ADIM}

Thus, the load current I_{LED} is stabilized to the target current amount I_{REF} which is in proportion to the analog dimming voltage V_{ADIM}.

Next, the PWM dimming will be described. In the PWM dimming, an effective light quantity is changed by changing the illumination time of the LED light source 502. A dimming pulse S_{PWMIN} from the host processor 400 is input to a PWMIN terminal. The dimming pulse S_{PWMIN} has a duty ratio corresponding to a target light quantity of the LED light source 502. A driver 330 switches a PWM dimming switch M2 according to the dimming pulse S_{PWMIN}.

Jitter is superimposed on the dimming pulse S_{PWMIN} generated by the host processor 400. As illustrated in FIG. 2, a timing of a positive edge/negative edge of the dimming pulse S_{PWMIN} is fluctuated randomly or periodically on the time axis due to the jitter, causing an error of the duty ratio (pulse width). When a duty ratio is large so the brightness of the LED light source 502 is high, the influence of the jitter may be neglected. However, when the duty ratio is small so the brightness of the LED light source 502 is low, the fluctuation of brightness resulting from the jitter, that is, flickering, is visible to human beings. In particular, since the eyes of humans have logarithmic sensitivity, low brightness and a small fluctuation in brightness may be easily recognized.

Further, in order to solve this problem, it is necessary to increase the clock accuracy of the host processor 400 for generating the dimming pulse S_{PWMIN}, but in this case, costs are increased. Here, the jitter is taken as an example as a factor of flickering, but flickering may also occur due to other factors, for example, noise. This problem must not be recognized by a range of common general knowledge in the art to which the present disclosure pertains, and it is recognized by the inventor of the present disclosure independently.

### SUMMARY

The present disclosure provides some embodiments of a reduction in flickering of PWM dimming.

According to one embodiment of the present disclosure, there is provided a control circuit of a driving circuit for supplying a driving current to a light source. The control circuit includes a pulse width modulation (PWM) input terminal configured to receive an input dimming pulse having an input duty ratio corresponding to a target light quantity of the light source and which is pulse-width modulated; and a dimming controller configured to convert a period and a pulse width of the input dimming pulse into digital values, reconvert the digital values into an output dimming pulse having an output duty ratio which is the same as or different from the input duty ratio, and control ON/OFF of the driving current based on the output dimming pulse.

According to this embodiment, it is possible to first convert the period and the pulse width of the input dimming pulse from the outside into digital values and then correct the output duty ratio as necessary, thereby suppressing the fluctuation in the duty ratio of the PWM dimming to reduce flickering.

In some embodiments, the dimming controller may include a measurement part configured to measure the period and the pulse width of the input dimming pulse to generate period data representing the period and input duty ratio data representing the pulse width; a correction part configured to generate output duty ratio data based on the input duty ratio data; and a reconversion part configured to generate the output dimming pulse based on the period data and the output duty ratio data.

The pulse width may have a section of a high level or a section of a low level.

In some embodiments, one of (i) the previous output duty ratio data and (ii) the input duty ratio data may be selected as the output duty ratio data.

When a change in the input duty ratio is highly likely to result from jitter or noise, the current input duty ratio data is neglected by setting the output duty ratio data to the previous output duty ratio data, thereby suppressing the fluctuation in the output duty ratio data.

In some embodiments, the correction part may include a memory configured to hold the previous output duty ratio data as reference duty ratio data, and may be configured to generate the output duty ratio data based on a result of comparison between the input duty ratio data and the reference duty ratio data.

Thus, it is possible to determine whether a change in input duty ratio data is resulted from intentional controlling or from the influence of jitter, noise, or the like.

The correction part may be configured to (i) maintain the output duty ratio data when the number of times of occurrence of the input duty ratio data that satisfies a predetermined condition regarding the reference duty ratio data is satisfied is smaller than a predetermined number of times, and (ii) update the memory based on the input duty ratio data by setting the input duty ratio data as new output duty ratio data when the number of times of occurrence exceeds the predetermined number of times.

In some embodiments, the predetermined condition may be that the input duty ratio data is smaller than the reference duty ratio data. Alternatively, the predetermined condition may be that the input duty ratio data is smaller than the reference duty ratio data by a predetermined value or greater.

The correction part may be configured to set (iii) the input duty ratio data as the new output duty ratio data when the input duty ratio data is greater than the reference duty ratio data.

The correction part may be configured to (iii-1) set the input duty ratio data as the new output duty ratio data when the input duty ratio data is greater than the reference duty ratio data and a difference between the reference duty ratio data and the input duty ratio data is greater than a first threshold value, and (iii-2) maintain the output duty ratio data when the input duty ratio data is greater than the reference duty ratio data and the difference is smaller than the first threshold value.

It is possible to adjust the sensitivity to jitter or noise based on the first threshold value.

In some embodiments, the predetermined condition may be that the input duty ratio data is greater than the reference duty ratio data. Alternatively, the predetermined condition may be that the input duty ratio data is greater than the reference duty ratio data by a predetermined value or greater.

The correction part may be configured to set (iii) the input duty ratio data as the new output duty ratio data when the input duty ratio data is smaller than the reference duty ratio data.

The correction part may be configured to (iii-1) set the input duty ratio data as the new output duty ratio data when the input duty ratio data is smaller than the reference duty ratio data and a difference between the reference duty ratio data and the input duty ratio data is greater than a first threshold value, and (iii-2) maintain the output duty ratio data when the input duty ratio data is smaller than the reference duty ratio data and the difference is smaller than the first threshold value.

It is possible to adjust the sensitivity to jitter or noise based on the first threshold value.

In some embodiments, the control circuit may further include a first register configured to store first data for setting the predetermined number of times. Thus, it is possible to set an optimal value for each platform on which the control circuit is used.

The control circuit may further include a second register configured to store second data for setting the first threshold value. Thus, it is possible to set an optimal value for each platform on which the control circuit is used.

When the duty ratio is large to a degree so the light source emits light brightly, it is difficult for a change in the duty ratio of PWM dimming to be recognized as flickering. Thus, when the duty ratio of the input dimming pulse is greater than a predetermined second threshold value, the dimming controller may not perform correction.

The control circuit may further include a third register configured to store third data for setting the second threshold value. Thus, it is possible to set an optimal value for each platform on which the control circuit is used.

The driving circuit may include a constant current converter. The control circuit may further include a feedback controller configured to control the constant current converter.

In some embodiments, the control circuit may be integrated on a single semiconductor substrate.

The term “integrated” may include a case in which all the components of a circuit are formed on a semiconductor substrate or a case in which major components of a circuit are integrated, and some resistors, capacitors, or the like may be installed outside the semiconductor substrate in order to adjust circuit constants.

According to another embodiment of the present disclosure, there is provided a driving circuit of a light source. The driving circuit includes a constant current converter; and any one of the control circuits described above.

According to still embodiment of the present disclosure, there is provided a lighting apparatus. The lighting apparatus may include a lighting emitting diode (LED) light source including a plurality of LEDs connected in series; a rectifying circuit configured to smooth and rectify a commercial AC voltage; a constant current converter configured to receive a DC voltage smoothed and rectified by the rectifying circuit as an input voltage and set the LED light source as a load; and any one of the control circuits described above.

According to a further embodiment of the present disclosure, there is provided an electronic device. The electronic device may include a liquid crystal panel; and the lighting apparatus as described above, which is a backlight configured to irradiate the liquid crystal panel from a back surface thereof.

Further, arbitrarily combining the foregoing components or converting the expression of the present disclosure among a method, an apparatus, and the like is also effective as an embodiment of the present disclosure.

### BRIEF DESCRIPTION OF THE DRAWINGS

FIG. 1 is a circuit diagram of a driving circuit of an LED.

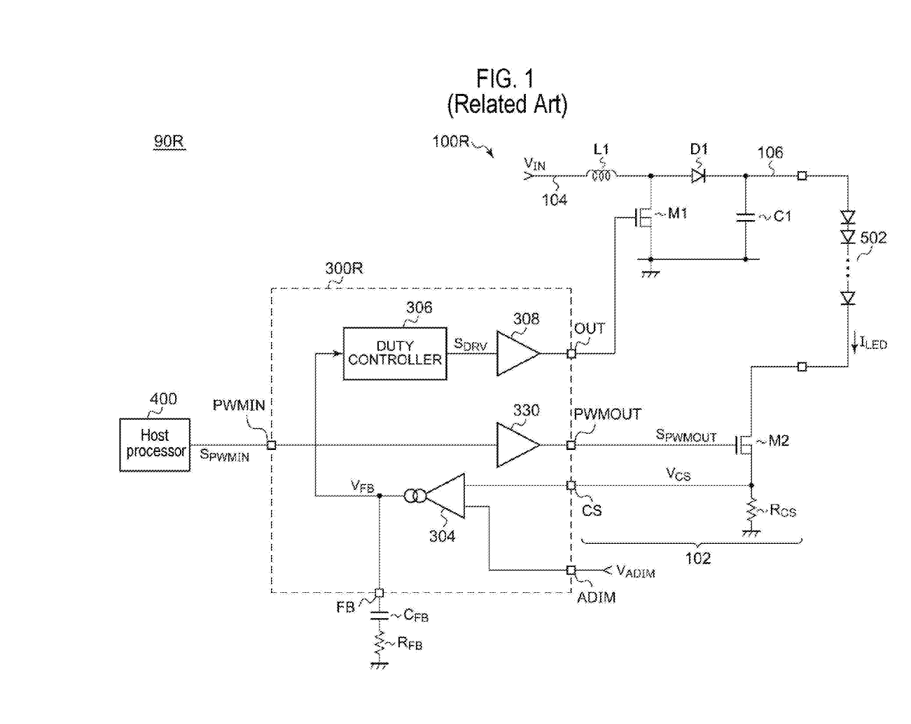

FIG. 2 is a waveform view illustrating analog dimming and PWM dimming.

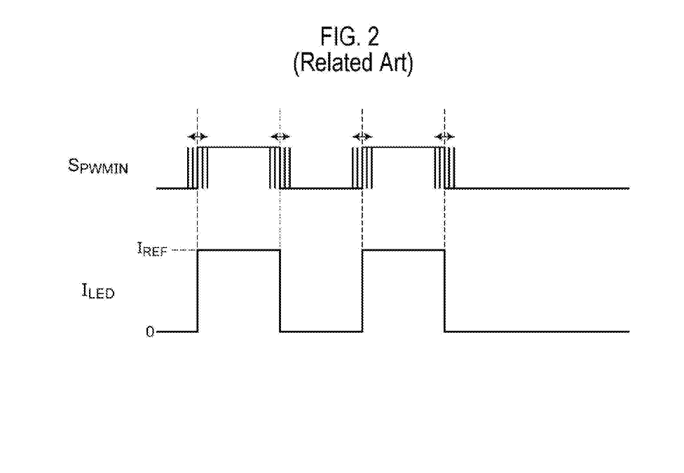

FIG. 3 is a block diagram of a driving circuit of a light source according to an embodiment.

FIGS. 4A and 4B are operational waveform views of a control circuit.

FIG. 5 is a block diagram illustrating a dimming controller.

FIG. 6 is a flowchart illustrating correction processing of a duty ratio.

FIG. 7 is a flowchart illustrating improved correction processing.

FIG. 8 is a block diagram of a correction part capable of performing the correction processing of FIG. 6 or 7.

FIG. 9 is a circuit diagram of a constant current converter according to a first configuration example.

FIG. 10 is a circuit diagram of a constant current converter according to a second configuration example.

FIG. 11 is a flow chart illustrating correction processing according to a second modification.

FIG. 12 is a block diagram of a lighting apparatus using an LED driver.

FIGS. 13A to 13C are views illustrating specific examples of a lighting apparatus.

### DETAILED DESCRIPTION

Embodiments of the present disclosure will be now described in detail with reference to the drawings. Like or equivalent components, members, and processes illustrated in each drawing are given like reference numerals and a repeated description thereof will be properly omitted. Further, the embodiments are presented by way of example only, and are not intended to limit the present disclosure, and any feature or combination thereof described in the embodiments may not necessarily be essential to the present disclosure.

In the present disclosure, “a state where a member A is connected to a member B” includes a case where the member A and the member B are physically directly connected or even a case in which the member A and the member B are indirectly connected through any other member that does not affect an electrical connection state thereof.

Similarly, “a state where a member C is installed between a member A and a member B” also includes a case where the member A and the member C or the member B and the member C are indirectly connected through any other member that does not affect an electrical connection state, in addition to a case in which the member A and the member C or the member B and the member C are directly connected.

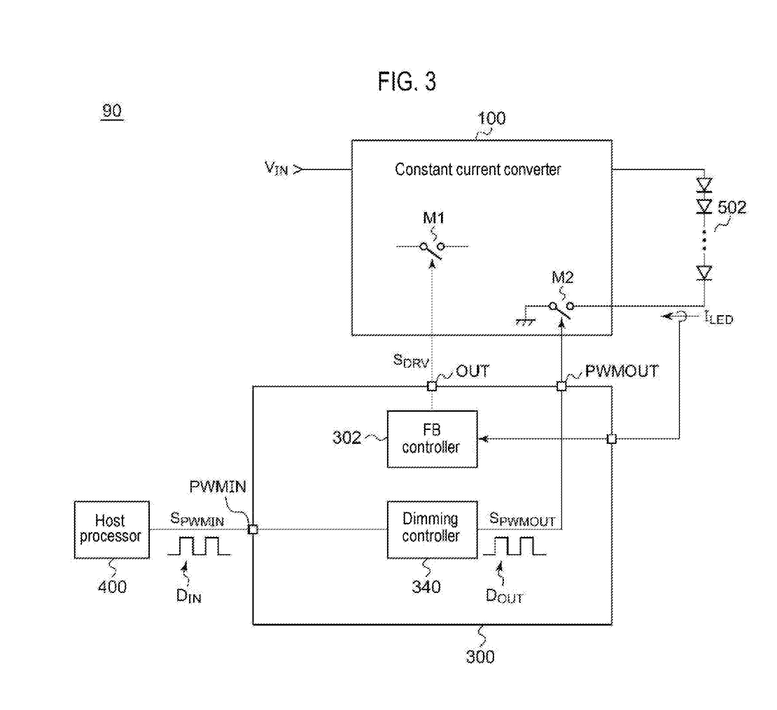

FIG. 3 is a block diagram of a driving circuit of a light source according to an embodiment of the present disclosure. A driving circuit (hereinafter, referred to as an LED driver) 90 mainly includes a constant current converter 100 for supplying a driving current I_{LED} to an LED light source 502 and a control circuit 300.

The LED light source 502 may be an LED string including a plurality of light emitting devices (LEDs) connected in series. The constant current converter 100 supplies a driving current I_{LED} stabilized to a target current I_{REF} corresponding to a target brightness to the LED light source 502.

The constant current converter 100 may be a step-up converter, a step-down converter, a step-up/step-down converter, a flyback converter, a forward converter, or the like, and a configuration thereof is not particularly limited.

The constant current converter 100 steps up or steps down an input voltage V_{IN} of an input line 104 to generate an output voltage V_{OUT} between both ends of the LED light source 502.

The control circuit 300, which is a functional integrated circuit (IC) integrated on a single semiconductor substrate, feedback-controls the constant current converter 100 and also switches ON/OFF of the driving current I_{LED} to perform PWM dimming.

The control circuit 300 includes an output (OUT) terminal, a PWM input (PWMIN) terminal, and a PWM output (PWMOUT) terminal. The OUT terminal is connected to a switching transistor M1 of the constant current converter 100.

The control circuit 300 mainly includes a feedback controller 302 and a dimming controller 340. The feedback controller 302 generates a driving pulse S_{DRV} whose duty ratio is adjusted such that the driving current I_{LED} supplied to the LED light source 502 is constant, and switches the switching transistor M1 according to the driving pulse S_{DRV}.

A control mode of the feedback controller 302 is not particularly limited, but may use any other known scheme such as a voltage mode, a peak current mode, an average current mode, or a hysteresis (Bang-Bang) control. Further, the configuration of the feedback controller 302 is not limited, but may be determined according to the control mode.

An input dimming pulse S_{PWMIN} having an input duty ratio D_{IN} corresponding to a target light quantity of the LED light source 502 from a host processor 400 is input to the PWMIN terminal. The dimming controller 340 may turn on or turn off the LED light source 502 at a high speed by controlling ON/OFF of the driving current I_{LED} according to the input dimming pulse S_{PWMIN}.

The dimming controller 340 reconverts a period T_{P} and a pulse width T_{ON} of the input dimming pulse S_{PWMIN} into digital values and converts the digital values into an output dimming pulse S_{PWMOUT} having an output duty ratio D_{OUT} which is the same as or different from the input duty ratio D_{IN}.

The dimming controller 340 may control a PWM dimming switch M2 according to the output dimming pulse S_{PWMOUT}. Further, the PWM dimming switch M2 is not necessarily essential, and the switching transistor M1 may serve as the PWM dimming switch M2 in a so-called step-down LED driver.

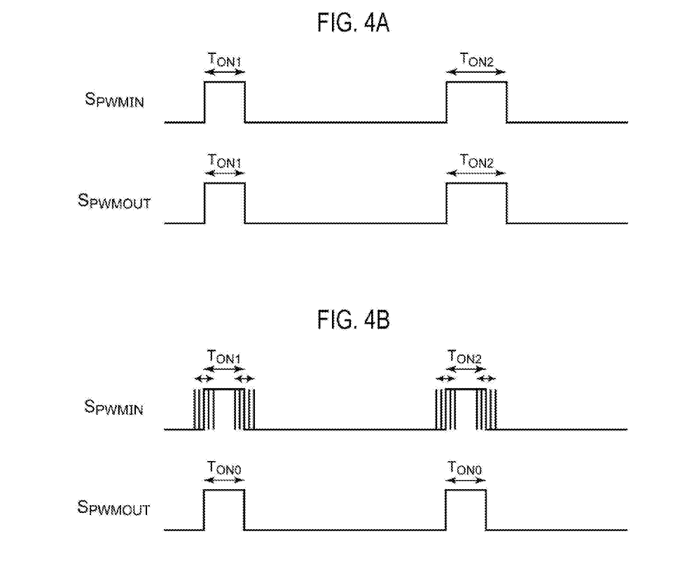

The configuration of the control circuit 300 has been described above. Next, an operation thereof will be described. FIGS. 4A and 4B are operational waveform views of the control circuit 300. FIG. 4A illustrates an operation when jitter and noise are not included in the input dimming pulse S_{PWMIN}. In this case, a pulse width (duty ratio) of the output dimming pulse S_{PWMOUT} is the same as that of the input dimming pulse S_{PWMIN}.

FIG. 4B illustrates an operation when jitter and noise are included in the input dimming pulse S_{PWMIN}. In this case, a pulse width (duty ratio) of the output dimming pulse S_{PWMOUT} has a value T_{ON0}, which is unrelated to that of the input dimming pulse S_{PWMIN}. In other words, an output duty ratio D_{OUT} has been corrected. The value T_{ON0} is desirable in many cases since a pulse width measured in the past may be used.

The operation of the control circuit 300 has been described above. The control circuit 300 may first convert the period T_{P} and the pulse width T_{ON} of the input dimming pulse S_{PWMIN} from the outside into digital values, and then correct the output duty ratio D_{OUT} (pulse width) as necessary, thereby suppressing the fluctuation in the duty ratio of the PWM dimming to reduce flickering.

The present disclosure is recognized by the block diagram and circuit diagram of FIG. 3, and encompasses various devices and circuits derived from the above description, and is not limited to a specific configuration. Hereinafter, a specific configuration example will be described in order to facilitate and clarify understanding of the essence and circuitry operation of the disclosure, rather than to narrow the scope of the present disclosure.

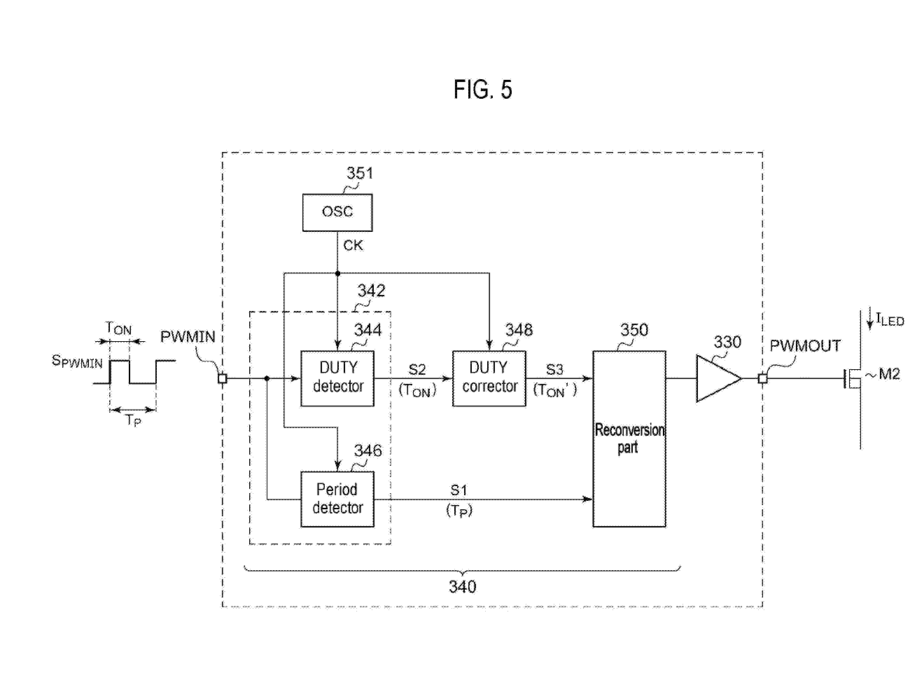

FIG. 5 is a block diagram illustrating the dimming controller 340. The dimming controller 340 includes a measurement part 342, a correction part 348, a reconversion part 350, and a driver 330.

The measurement part 342 measures a period T_{P} and a pulse width T_{ON} of an input dimming pulse S_{PWMIN} to generate period data S1 representing the period T_{P} and input duty ratio data S2 representing the pulse width T_{ON}.

A duty ratio detector 344 may be configured as a digital counter for measuring the pulse width T_{ON} of the input dimming pulse S_{PWMIN}, in other words, a duty ratio, using a sufficiently fast clock CK generated by an oscillator 351. In this case, the input duty ratio data S2 is a count value, and S2=T_{ON}/T_{CK}. Here, T_{CK} is a clock period.

Similarly, a period detector 346 may be configured as a digital counter for measuring the period T_{P} of the input dimming pulse S_{PWMIN} using the clock CK. The period data S1 is a count value, and S1=T_{P}/T_{CK}.

The duty ratio detector 344 and the period detector 346 may share the same counter.

The correction part 348 generates output duty ratio data S3 indicating a pulse width T_{ON}′ (duty ratio D_{OUT}) of the output dimming pulse S_{PWMOUT} according to the input duty ratio data S2.

The reconversion part 350 generates an output dimming pulse S_{PWMOUT} based on the period data S1 and the output duty ratio data S3. The output dimming pulse S_{PWMOUT} has a period T_{P} represented by the period data S1, and has a pulse width T_{ON}′ represented by the output duty ratio data S3. The reconversion part 350 may be configured as a digital counter. The reconversion part 350 sets a count number represented by the output duty ratio data S3, a period in which the clock CK is counted, and the output dimming pulse S_{PWMOUT} to a first level (for example, a high level). Subsequently, the reconversion part 350 sets a count number of (S1-S2), a period in which the clock CK is counted, and the output dimming pulse S_{PWMOUT} to a second level (for example, a low level).

Further, the configurations of the measurement part 342 and the reconversion part 350 are not particularly limited and they may be differently configured. The configuration example of the dimming controller 340 has been described above.

Subsequently, the process of the correction part 348 will be described.

The correction part 348 may select one of (i) the previous output duty ratio data (reference duty ratio data) S4 and (ii) the input duty ratio data S2 to output it as the output duty ratio data S3. The reference duty ratio data S4 corresponds to the pulse width T_{ON0} of FIG. 4B, and the value is referred to as a reference duty ratio D_{REF}.

When a change in the input duty ratio D_{IN} is highly likely to result from the jitter or noise, the current input duty ratio data S2 is neglected and the reference duty ratio data S4 is selected as the output duty ratio data S3. Accordingly, the previous output duty ratio is maintained, and thus, the influence of the jitter and noise can be removed from the output duty ratio data D3.

The correction part 348 may include a memory for holding the value D_{REF} of the reference duty ratio data S4. The correction part 348 determines the value D_{OUT} of the output duty ratio data S3 based on a result of the comparison between the value D_{IN} of the current input duty ratio data S2 and the value D_{REF} of the reference duty ratio data S4.

(i) When the number of times of occurrence of the input duty ratio data S2 having the value D_{IN} that satisfies a predetermined condition regarding the value D_{REF} of the reference duty ratio data S4 is smaller than a predetermined number of times B, the correction part 348 maintains the value D_{OUT} of the output duty ratio data S3. Further, (ii) when the number of times of occurrence exceeds the predetermined number of times B, the correction part 348 sets the value D_{IN} of the input duty ratio data S2 to the value D_{OUT} of the new output duty ratio data S3. Further, the correction part 348 updates the value D_{REF} of the memory with the value D_{IN} of the input duty ratio data S2.

In this embodiment, the predetermined condition is that the value D_{IN} of the input duty ratio data S2 is smaller than the value D_{REF} of the reference duty ratio data S4 as follows:

D_{IN}<D_{REF}

When the duty ratio is large to some extent and the light source emits light brightly, it is difficult for a change in the duty ratio of PWM dimming to be recognized as flickering. Thus, in this situation, there is no need to perform a correction. Accordingly, when the duty ratio D_{IN} of the input dimming pulse S_{PWMIN} is greater than a predetermined threshold value A, the dimming controller 340 may not perform a correction.

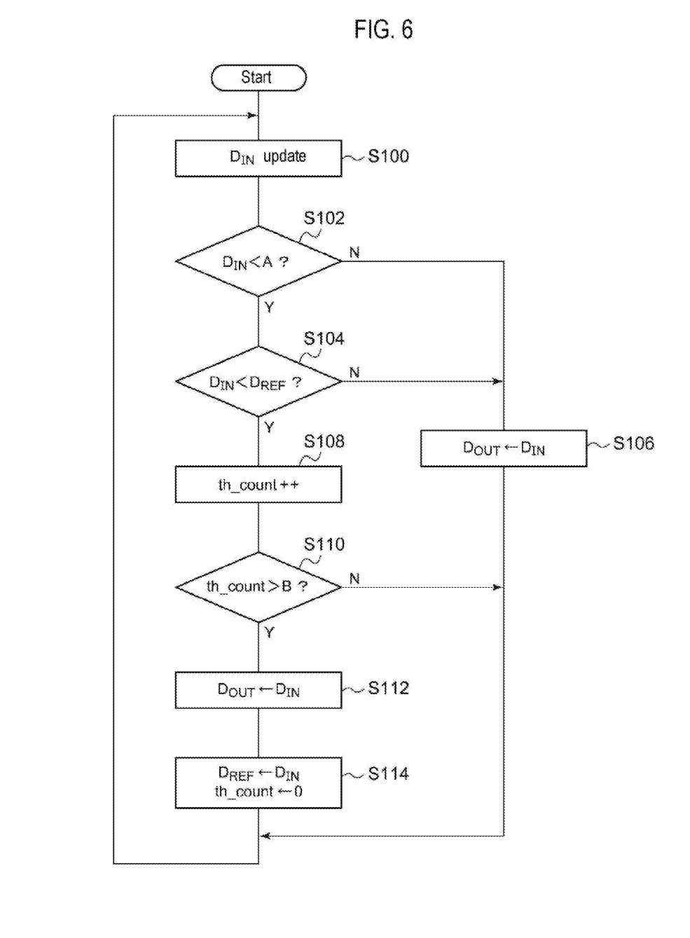

FIG. 6 is a flowchart illustrating a correction processing of a duty ratio. In FIG. 6, the processing of 1 cycle of the input dimming pulse S_{PWMIN} is illustrated. First, a pulse width T_{ON} of the input dimming pulse S_{PWMIN} is measured and the value D_{IN} of the input duty ratio data S2 is updated. Subsequently, the value D_{IN} and the threshold value A are compared (S102). When the value D_{IN} is greater (N in S102), the value D_{IN} of the current input duty ratio data S2 becomes the value D_{OUT} of the new output duty ratio data S3 (S106).

When the value D_{IN} is smaller (Y in S102), the value D_{IN} of the current input duty ratio data S2 is compared with the value D_{REF} of the reference duty ratio data S4 stored in the memory to determine whether the predetermined condition (D_{IN}<D_{REF}) is satisfied (S104). When the predetermined conditions is not satisfied (D_{IN}>D_{REF}, N in S104), the value D_{IN} of the current input duty ratio data S2 becomes the value D_{OUT} of the new output duty ratio data S3 (S106).

In step S104, when the predetermined condition (D_{IN}<D_{REF}) is satisfied (Y in S104), the data th_count indicating the number of times of occurrence th_count is increased (S108). Further, when the number of times of occurrence th_count is smaller than a threshold value B (N in S110), the value D_{OUT} of the output duty ratio data S3 is not updated, and thus, the previous value is maintained.

When the number of times of occurrence th_count exceeds the threshold value B (Y in S110), the value D_{OUT} of the output duty ratio data S3 becomes the value D_{IN} of the input duty ratio data S2 (S112). And then, the value D_{REF} of the reference duty ratio data S4 of the memory is updated with the value D_{IN} of the input duty ratio data S2, and the number of times of occurrence th_count is reset (S114).

According to this processing, when the input duty ratio D_{IN} smaller than the current output duty ratio D_{OUT} is generated, if the number of times of occurrence th_count exceeds the predetermined number B, it may be estimated that the duty ratio has been controlled to be lowered (not lowered due to the jitter or noise).

Flickering caused by the jitter or noise is noticeable particularly in an area with a small duty ratio. Thus, when the input duty ratio D_{IN} is smaller than before, flicking can be appropriately suppressed by counting the number of times.

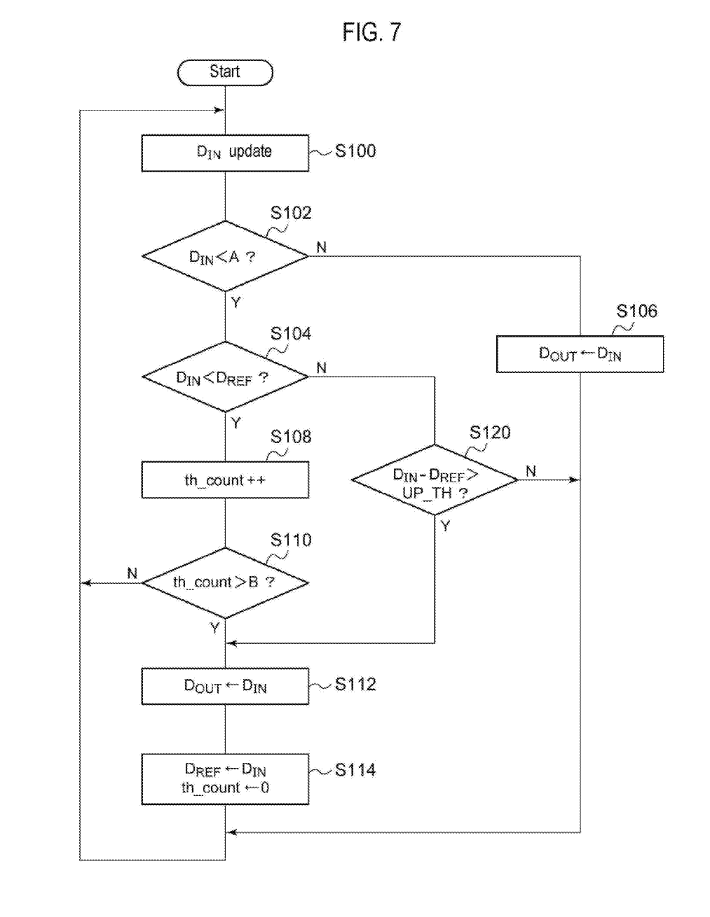

FIG. 7 is a flowchart illustrating improved correction processing. The correction processing further includes step S120.

In FIG. 7, when the predetermined condition is not satisfied (D_{N}>D_{REF}), the processing is different. When the value D_{IN} is greater than the value D_{REF} based on a result of comparison between the value D_{IN} and the value D_{REF} (N in S104), the process proceeds to step S120. Further, when a difference (increase) (D_{IN}−D_{REF}) is greater than a first threshold value UP_TH (Y in S120), the process proceeds to step S112 in which the value D_{IN} of the input duty ratio data S2 becomes the value D_{OUT} of the output duty ratio data D3.

When the difference (increase) (D_{IN}−D_{REF}) is smaller than the first threshold value UP_TH (N in S120), the value D_{OUT} of the output duty ratio data S3 is not updated, and thus, the previous value is maintained.

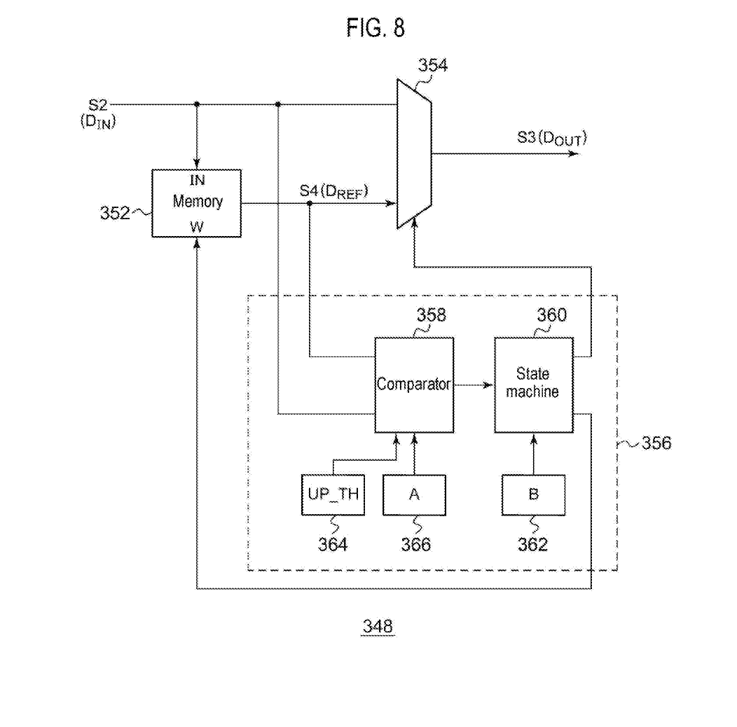

FIG. 8 is a block diagram of the correction part 348 capable of performing the correction processing of FIG. 6 or 7. The correction part 348 includes a memory 352, a selector 354, and a correction control part 356. The memory 352 holds the value D_{REF} of the reference duty ratio data S4. The selector 354 selects one of the value D_{IN} of the input duty ratio data S2 and the value D_{REF} of the reference duty ratio data S4 and sets it to the value D_{OUT} of the output duty ratio data S3.

The correction control part 356 controls the memory 352 and the selector 354. The comparator 358 compares the value D_{IN} and the value D_{REF} (S102, S104, and S120). A state machine 360 controls the selector 354 based on the comparison result of the comparator 358, and also controls the writing into the memory 352.

A first register 362 stores first data for setting the predetermined number of times B. A second register 364 stores second data for setting the first threshold value UP_TH. A third register 366 stores third data for setting a second threshold value A.

Since various parameters can be set by the registers, it is possible to set an optimal value for each platform on which the control circuit 300 is used.

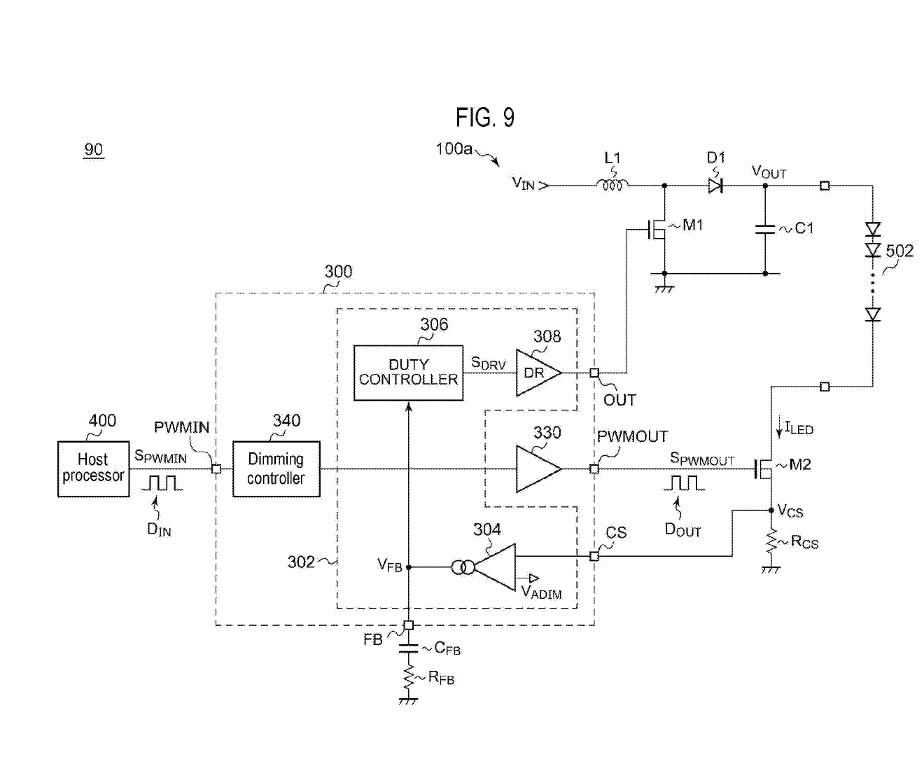

FIG. 9 is a circuit diagram of a constant current converter 100a according to a first configuration example. The constant current converter 100a is a step-up converter (Booster converter), and includes an inductor L1, a switching transistor M1, a rectifying diode D1, and a smoothing capacitor C1. The rectifying diode D1 may be a synchronous rectifying transistor.

A PWM dimming switch M2 and a detection resistor R_{CS} are provided on the path of a driving current I_{LED}. A voltage drop of the detection resistor R_{CS} is input to a current detection terminal CS of the control circuit 300. A feedback controller 302 includes an error amplifier 304, a duty controller 306, and a driver 308. The error amplifier 304 amplifies an error between the detection voltage V_{CS} and an analog dimming voltage V_{ADIM} to generate a feedback signal V_{FB}. The error amplifier 304 may include a transconductance amplifier, a phase compensation capacitor C_{FB} and a resistor R_{FB}. The duty controller 306 generates a driving pulse S_{DRV} of a duty ratio based on the feedback signal V_{FB}. The driver 308 switches a switching transistor M1 according to the driving pulse S_{DRV}.

A constant current source may be provided instead of the detection resistor R_{CS}. In this case, the feedback controller 302 switches the switching transistor M1 such that a voltage across the constant current source is identical to a predetermined reference voltage V_{REF}. The PWM dimming switch M2 may be included in the constant current source.

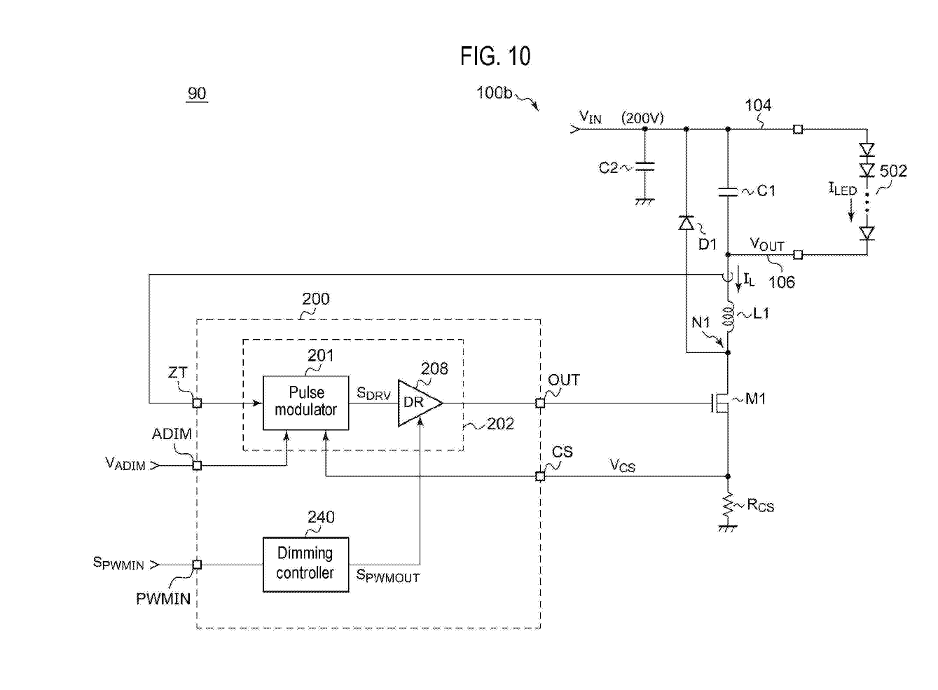

FIG. 10 is a circuit diagram of a constant current converter 100b according to a second configuration example. The constant current converter 100b is a step-down converter (Buck converter) which steps down an input voltage V_{IN} of an input line 104 and outputs the stepped-down output voltage V_{OUT} from an output line 106. One end (anode) of the LED light source 502 is connected to the input line 104, and the other end (cathode) thereof is connected to the output line 106. A driving voltage V_{IN}-V_{OUT} is supplied between both ends of the LED light source 502.

The LED light source 502, which is a device to be driven with a constant current, may be, for example, an LED string including a plurality of light emitting devices (LEDs) connected in series. The constant current converter 100 stabilizes a driving current I_{LED} flowing in the LED light source 502 to a target current I_{REF} corresponding to a target brightness.

An output circuit 102 includes a smoothing capacitor C1, an input capacitor C2, a rectifying diode D1, a switching transistor M1, an inductor L1, and a detection resistor R_{CS}. One end of the smoothing capacitor C1 is connected to the input line 104, and the other end of the smoothing capacitor C1 is connected to the output line 106.

One end of the inductor L1 is connected to the output line 106, and the other end of the inductor L1 is connected to a drain of the switching transistor M1. The detection resistor R_{CS} is disposed on the path of a current (inductor current) I_{L} flowing in the switching transistor M1 and the inductor L1 during an ON period of the switching transistor M1. A cathode of the rectifying diode D1 is connected to the input line 104, and an anode of the rectifying diode D1 is connected to a connection point N1 (drain) of the switching transistor M1 and the inductor L1.

A control circuit 200 is a functional IC integrated on a single semiconductor substrate and includes an output (OUT) terminal, a current detection (CS) terminal, a zero-cross detection (ZT) terminal, a ground (GND) terminal, a pulse dimming input (PWMIN) terminal, and an analog dimming (ADIM) terminal. The GND terminal is grounded. The OUT terminal is connected to a gate of the switching transistor M1, and a detection voltage V_{CS} corresponding to a voltage drop of the detection resistor R_{CS} is input to the CS terminal. The switching transistor M1 may be incorporated in the control circuit 200. An analog dimming voltage V_{ADIM} indicating the inductor current I_{L} and furthermore, a target amount I_{REF} of a driving current I_{LED}, from the host processor 400 (not shown) is input to the ADIM terminal.

The control circuit 200 includes a feedback controller 202 and a dimming controller 340. The feedback controller 202 includes a pulse modulator 201 and a driver 208. The pulse modulator 201 generates a driving pulse S_{DRV} whose duty ratio is adjusted such that a current detection signal I_{S} based on the detection voltage V_{CS} is close to a current set signal I_{REF} based on the analog dimming voltage V_{ADIM}. The driver 208 drives the switching transistor M1 of the constant current converter 100a based on the driving pulse S_{DRV}.

An input dimming pulse S_{PWMIN} having an input duty ratio D_{IN} is input to the PWMIN terminal. Upon receipt of the input dimming pulse S_{PWMIN}, the dimming controller 340 generates an output dimming pulse S_{PWMOUT}. The dimming controller 340 is the same as described above.

In this constant current converter 100b, the switching transistor M1 serves as a PWM dimming switch. The driver 208 switches the switching transistor M1 during a period in which the output dimming pulse S_{PWMOUT} is in an ON level (for example, a high level), and stops the switching during a period in which the output dimming pulse S_{PWMOUT} is in an OFF level (for example, a low level). The output dimming pulse S_{PWMOUT} may be input to the pulse modulator 201. In this case, the pulse modulator 201 may fix the driving pulse S_{DRV} to a low level during a period in which the output dimming pulse S_{PWMOUT} is in an OFF level.

It is to be understood by those skilled in the art that the embodiments are merely illustrative and may be variously modified by any combination of the components or processes, and the modifications are also within the scope of the present disclosure. Hereinafter, these modifications will be described.

### First Modification

In the embodiment, regarding the correction processing of the correction part 348 illustrated in FIG. 6 or 7, the predetermined condition is set to D_{N}<D_{REF}, but the present disclosure is not limited thereto. A predetermined value D may be defined and the predetermined condition determined in step S104 may be set as follows:

D_{IN}<D_{REF}−D

In this case, the sensitivity to jitter or noise may be adjusted based on the predetermined value D.

### Second Modification

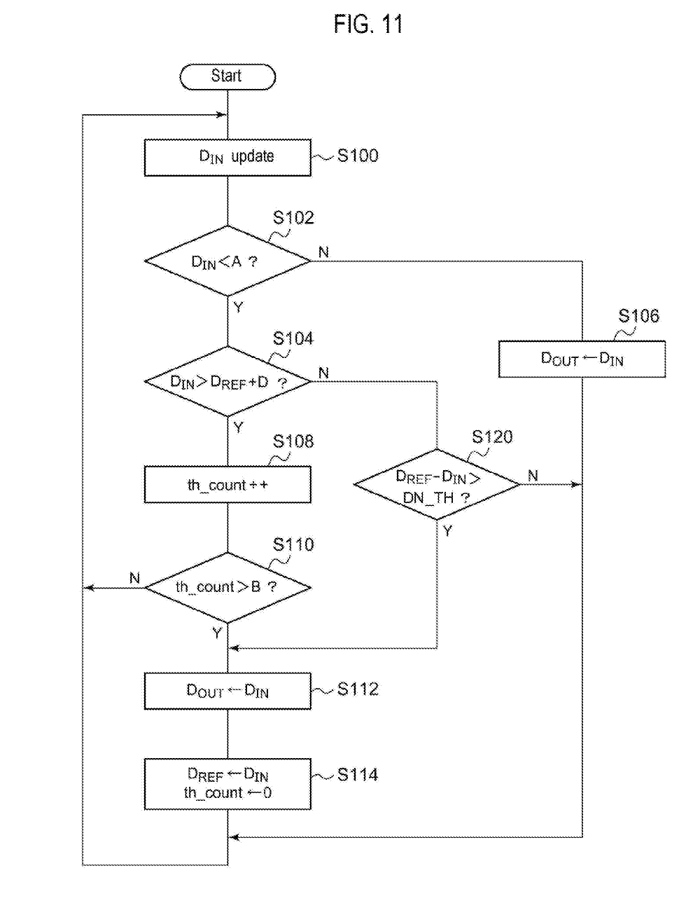

FIG. 11 is a flowchart illustrating correction processing according to a second modification. The predetermined condition of step S104 is as follows:

D_{IN}>D_{REF}+D

A relationship regarding the size is opposite to that of the first modification, and a condition of the second modification is that the value D_{IN} of the input duty ratio data S2 is greater than the value D_{REF} of the reference duty ratio data S4 by a predetermined value E or greater.

Further, in step S120, (iii-1) when the value D_{IN} of the input duty ratio data S2 is smaller than the value D_{REF} of the reference duty ratio data S4 and when a difference D_{REF}-D_{IN} between the value D_{REF} of the reference duty ratio data S4 and the value D_{IN} of the input duty ratio data S2 is greater than the first threshold value DN_TH (Y in S120), the input duty ratio data S2 is set to new output duty ratio data S3, and when (iii-2) the difference D_{REF}-D_{N} is smaller than the first threshold value DN_TH (N in S120), the output duty ratio data is maintained.

### Third Modification

Alternatively, the predetermined condition determined in step S104 of the flowchart of FIG. 11 may be simplified as follows:

D_{IN}>D_{REF}

### Fourth Modification

In the embodiment, the case in which the LED light source 502 is an LED string has been described, but the type of the load is not particularly limited and the present disclosure may also be applied to various different loads to be driven with a constant current, as well as to the light source.

### Fifth Modification

In this embodiment, the setting of a logic value of a high level or a low level of a logic circuit may be an example and may be freely changed by appropriately inverting the values by an inverter, or the like.

### (Applications)

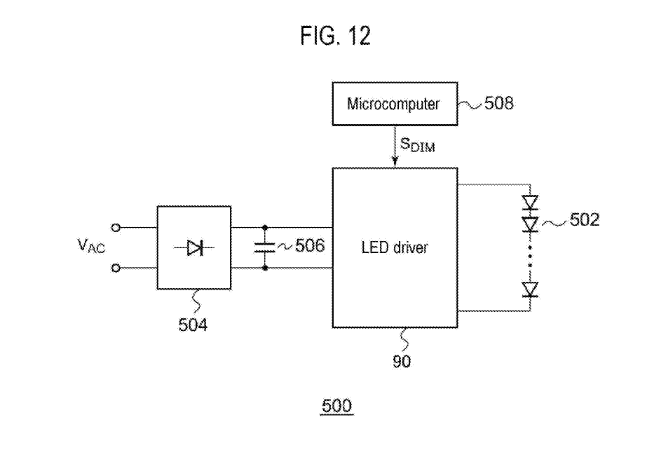

Finally, the applications of the constant current converter 100 will be described. FIG. 12 is a block diagram of a lighting apparatus 500 using an LED driver 90. The lighting apparatus 500 includes a rectifying circuit 504, a smoothing capacitor 506, and a microcomputer 508, in addition to a light emitting part as the LED light source 502 and the LED driver 90. The rectifying circuit 504 and the smoothing capacitor 506 rectify and smooth a commercial AC voltage V_{AC} to convert the voltage into a DC voltage V_{DC}. The microcomputer 508 generates a control signal S_{DIM} indicating the brightness of the LED light source 502. The LED driver 90 receives the DC voltage V_{DC} as an input voltage V_{IN} and supplies a driving current I_{LED} according to the control signal S_{DIM} to the LED light source 502. The control signal S_{DIM} includes the analog dimming voltage V_{ADIM} and the dimming pulse S_{PWMIN} described above.

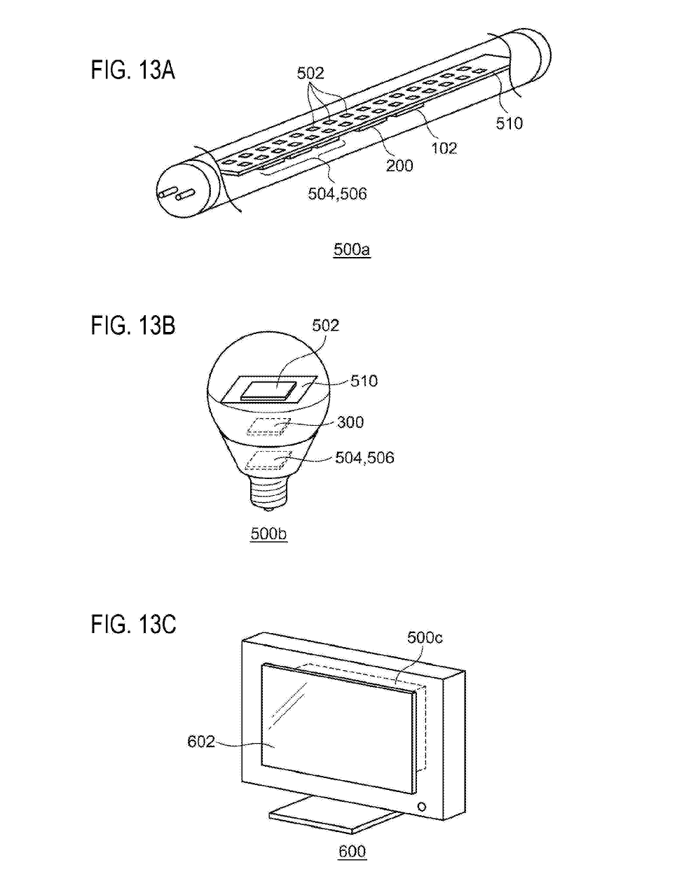

FIGS. 13A to 13C are views illustrating specific examples of the lighting apparatus 500. In FIGS. 13A to 13C, all the components are not shown and some of them are omitted. A lighting apparatus 500a of FIG. 13A is a tubular LED lighting. A plurality of LED devices constituting an LED string as the LED light source 502 are arranged on a board 510. A rectifying circuit 504, a control circuit 200, the output circuit 102 of the constant current converter 100, and the like are mounted on the board 510. The output circuit 102 includes an inductor L1, a switching transistor M1, a rectifying diode D1, and a smoothing capacitor C1.

A lighting apparatus 500b of FIG. 13B is a bulb-type LED lighting. An LED module as the LED light source 502 is mounted on a board 510. A control circuit 200 and a rectifying circuit 504 are mounted within the housing of the lighting apparatus 500b.

A lighting apparatus 500c of FIG. 13C is a backlight incorporated in a liquid crystal display (LCD) 600. The lighting apparatus 500c irradiates the back surface of a liquid crystal panel 602.

Alternatively, the lighting apparatus 500 may be used for ceiling lights. In this manner, the lighting apparatus 500 of FIG. 12 may be used for various applications.

According to the present disclosure in some embodiments, it is possible to reduce the flickering of PWM dimming.

While certain embodiments have been described, these embodiments have been presented by way of example only, and are not intended to limit the scope of the disclosures. Indeed, the embodiments described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A control circuit of a driving circuit for supplying a driving current to a light source, comprising:
a pulse width modulation (PWM) input terminal configured to receive an input dimming pulse having an input duty ratio corresponding to a target light quantity of the light source, the input dimming pulse being pulse-width modulated; and
a dimming controller configured to convert a period and a pulse width of the input dimming pulse into digital values, reconvert the digital values into an output dimming pulse having an output duty ratio which is the same as or different from the input duty ratio, and control the driving current to be on and off based on the output dimming pulse.

2. The control circuit of claim 1, wherein the dimming controller comprises:
a measurement part configured to measure the period and the pulse width of the input dimming pulse to generate a period data representing the period and an input duty ratio data representing the pulse width;
a correction part configured to generate an output duty ratio data based on the input duty ratio data; and
a reconversion part configured to generate the output dimming pulse based on the period data and the output duty ratio data.

3. The control circuit of claim 2, wherein one of (i) a previous output duty ratio data which is previously generated by the correction part and (ii) the input duty ratio data is selected as the output duty ratio data.

4. The control circuit of claim 3, wherein the correction part comprises a memory configured to hold the previous output duty ratio data as reference duty ratio data, and is configured to generate the output duty ratio data based on a result of comparison between the input duty ratio data and the reference duty ratio data.

5. The control circuit of claim 4, wherein the correction part is configured to (i) maintain the output duty ratio data when the number of times of occurrence of the input duty ratio data that satisfies a predetermined condition regarding the reference duty ratio data is smaller than a predetermined number of times, and (ii) update the memory based on the input duty ratio data by setting the input duty ratio data as a new output duty ratio data when the number of times of occurrence exceeds the predetermined number of times.

6. The control circuit of claim 5, wherein the predetermined condition is that the input duty ratio data is smaller than the reference duty ratio data.

7. The control circuit of claim 5, wherein the predetermined condition is that the input duty ratio data is smaller than the reference duty ratio data by a predetermined value or greater.

8. The control circuit of claim 6, wherein the correction part is configured to set (iii) the input duty ratio data as the new output duty ratio data when the input duty ratio data is greater than the reference duty ratio data.

9. The control circuit of claim 6, wherein the correction part is configured to (iii-1) set the input duty ratio data as the new output duty ratio data when the input duty ratio data is greater than the reference duty ratio data and a difference between the reference duty ratio data and the input duty ratio data is greater than a first threshold value, and (iii-2) maintain the output duty ratio data when the input duty ratio data is greater than the reference duty ratio data and the difference is smaller than the first threshold value.

10. The control circuit of claim 5, wherein the predetermined condition is that the input duty ratio data is greater than the reference duty ratio data.

11. The control circuit of claim 5, wherein the predetermined condition is that the input duty ratio data is greater than the reference duty ratio data by a predetermined value or greater.

12. The control circuit of claim 10, wherein the correction part is configured to set (iii) the input duty ratio data as the new output duty ratio data when the input duty ratio data is smaller than the reference duty ratio data.

13. The control circuit of claim 10, wherein the correction part is configured to (iii-1) set the input duty ratio data as the new output duty ratio data when the input duty ratio data is smaller than the reference duty ratio data and a difference between the reference duty ratio data and the input duty ratio data is greater than a first threshold value, and (iii-2) maintain the output duty ratio data when the input duty ratio data is smaller than the reference duty ratio data and the difference is smaller than the first threshold value.

14. The control circuit of claim 5, further comprising a first register configured to store first data for setting the predetermined number of times.

15. The control circuit of claim 9, further comprising a second register configured to store second data for setting the first threshold value.

16. The control circuit of claim 1, wherein the dimming controller is configured not to perform a correction when the input duty ratio of the input dimming pulse is greater than a predetermined second threshold value.

17. The control circuit of claim 16, further comprising a third register configured to store third data for setting the second threshold value.

18. The control circuit of claim 1, wherein the driving circuit comprises a constant current converter, and the control circuit further comprises a feedback controller configured to control the constant current converter.

19. The control circuit of claim 1, wherein the control circuit is integrated on a single semiconductor substrate.

20. A driving circuit of a light source, comprising:
a constant current converter; and
the control circuit of claim 1.

21. A lighting apparatus, comprising:
a lighting emitting diode (LED) light source including a plurality of LEDs connected in series;
a rectifying circuit configured to smooth and rectify a commercial AC voltage;
a constant current converter configured to receive a DC voltage smoothed and rectified by the rectifying circuit as an input voltage and set the LED light source as a load; and
the control circuit of claim 1.

22. An electronic device, comprising:
a liquid crystal panel; and
the lighting apparatus of claim 21, which is a backlight configured to irradiate the liquid crystal panel from a backside of the liquid crystal panel.

23. A method for driving a light source, comprising:
converting a period and a pulse width of an input dimming pulse having an input duty ratio into digital values;
reconverting the digital values into an output dimming pulse having an output duty ratio which is the same as or different from the input duty ratio; and
switching a PWM dimming switch which is responsive to the output dimming pulse and is arranged on a path of a driving current flowing in the light source or an inductor current flowing in an inductor of a constant current converter.

24. The method of claim 23, wherein the act of reconverting the digital values into the output dimming pulse comprises:
measuring the period and the pulse width of the input dimming pulse to generate period data representing the period and input duty ratio data representing the pulse width;
generating output duty ratio data based on the input duty ratio data; and
generating the output dimming pulse based on the period data and the output duty ratio data.
